(19) United States
(12) Patent Application Publication
(10) Pub. No.: US 2025/0282441 A1
(43) Pub. Date: Sep. 11, 2025

(54) CLAMPING DEVICE, ELECTRONIC DEVICE ASSEMBLY, AND BICYCLE

(71) Applicant: Yamaha Hatsudoki Kabushiki Kaisha, Shizuoka (JP)

(72) Inventor: Norihiro MOROZUMI, Shizuoka (JP)

(21) Appl. No.: 19/073,049

(22) Filed: Mar. 7, 2025

(30) Foreign Application Priority Data
Mar. 8, 2024 (JP) 2024-036254

(51) Int. Cl. B62J 50/21; B62J 50/22

(52) U.S. Cl. CPC B62J 50/225; B62J 50/22

(57) ABSTRACT

Fastening unit configured to fix a distance between a first adjusting g portion and a second adjusting portion in a circumferential direction of a handlebar is provided. A first engaging portion and a second engaging portion are located between a first engaged portion and a second engaged portion in a tangential direction of an outer circumferential surface of the handlebar. The fastening unit allows adjustment of the distance between the first adjusting portion and the second adjusting portion. A distance between the first engaging portion and the second engaging portion increases due to a decrease in the distance between the first adjusting portion and the second adjusting portion.

### CROSS-REFERENCE TO RELATED APPLICATION

The present application claims priority from Japanese application JP2024-036254 filed on Mar. 8, 2024, the content of which is hereby incorporated by reference into this application.

### BACKGROUND OF THE INVENTION

### 1. Field of the Invention

The present disclosure relates to a clamping device, an electronic device assembly, and a bicycle.

### 2. Description of the Related Art

A handlebar of a bicycle may be equipped with an electronic device that displays vehicle speed, traveled distance, time, and the like. In JP 2544082 Y2, such an electronic device is detachable from a clamping device (a component attaching device in JP 2544082 Y2) attached to a handlebar. As illustrated in JP 2015-085919 A, an electronic device attached to a handlebar of an electrically assisted bicycle may display an assist mode, a remaining battery charge amount, and the like and have a switch (button) for switching the assist mode.

Other than the electronic device described above that displays vehicle speed and the like, various parts and devices may be attached to a handlebar of a bicycle. For example, a clamping device for supporting a mobile phone, a lighting device, and the like may be attached to the handlebar. Therefore, flexibility in positioning of the clamping device is limited, so that it may be difficult to attach the electronic device in an optimal position. For example, a button may be located far away from a grip.

An object of the present disclosure is to provide a clamping device that enables position adjustment of an electronic device and that can facilitate easily adjusting a position of the electronic device.

### SUMMARY OF THE INVENTION

(1) An example of a clamping device proposed in the present disclosure is a clamping device for attaching an electronic device including a first engaged portion and a second engaged portion to a handlebar. The clamping device includes a first clamping member having a first inner circumferential surface extending along a portion of an outer circumferential surface of the handlebar, a first engaging portion engageable with the first engaged portion to allow movement of the first engaged portion in a longitudinal direction of the handlebar, and a first adjusting portion, a second clamping member having a second inner circumferential surface extending along another portion of the outer circumferential surface of the handlebar, a second engaging portion engageable with the second engaged portion to allow movement of the second engaged portion in the longitudinal direction of the handlebar, and a second adjusting portion, and fastening unit configured to fix a distance between the first adjusting portion and the second adjusting portion in a circumferential direction of the handlebar. The first engaging portion and the second engaging portion are located between the first engaged portion and the second engaged portion in a tangential direction of the outer circumferential surface of the handlebar. The fastening unit allows adjustment of the distance between the first adjusting portion and the second adjusting portion. A distance between the first engaging portion and the second engaging portion increases due to a decrease in the distance between the first adjusting portion and the second adjusting portion.

According to the clamping device, both of a relative position between the clamping device and the handlebar and a relative position between the clamping device and the electronic device can be adjusted or fixed by operating the fastening unit. Therefore, position adjustment thereof can be facilitated.

(2) The clamping device according to (1) may further include a connecting shaft portion. The first clamping member and the second clamping member respectively have a first connected portion and a second connected portion located between the first engaging portion and the second engaging portion in the tangential direction of the outer circumferential surface of the handlebar. The connecting shaft portion connects the first connected portion and the second connected portion to allow an increase and decrease in the distance between the first engaging portion and the second engaging portion. Such a structure makes it possible to prevent separation of the two clamping members. As a result, the clamping device is easy to handle.

(3) In the clamping device according to (2), the connecting shaft portion protrudes from the first connected portion in the longitudinal direction of the handlebar. A connecting hole into which the connecting shaft portion is fitted may be formed in the second connected portion. The connecting hole may be larger than the connecting shaft portion in the tangential direction of the outer circumferential surface of the handlebar.

(4) In the clamping device according to (3), a distance between the connecting shaft portion and the outer circumferential surface of the handlebar may be smaller than a distance between the outer circumferential surface of the handlebar and a first plane passing through the first engaging portion and the second engaging portion, the first plane extending along a first tangent line to the outer circumferential surface of the handlebar. Such an arrangement of the connecting shaft portion allows a size of the connecting hole in the tangential direction of the outer circumferential surface of the handlebar to be decreased. As a result, a decrease in strength of the second clamping member can be prevented.

(5) In the clamping device according to any one of (1) to (4), the first adjusting portion, a contact surface between the first inner circumferential surface and the outer circumferential surface of the handlebar, and the first engaging portion respectively function as a point of effort, a fulcrum point, and a point of load. The second adjusting portion, a contact surface between the second inner circumferential surface and the outer circumferential surface of the handlebar, and the second engaging portion respectively function as a point of effort, a fulcrum point, and a point of load.

(6) In the clamping device according to any one of (1) to (5), the distance between the outer circumferential surface of the handlebar and the first plane and passing through the first engaging portion and the second engaging portion may be greater than a distance between the outer circumferential surface of the handlebar and a second plane passing through the first adjusting portion and the second adjusting portion, the first plane extending along the first tangent line to the outer circumferential surface of the handlebar, and the second plane extending along a second tangent line to the outer circumferential surface of the handlebar. Accordingly, when positions of the two adjusting portions are fixed by the fastening unit, it is possible to prevent an excessive force from acting between the first engaging portion of the first clamping member and the first engaged portion of the electronic device, and prevent an excessive force from acting between the second engaging portion of the second clamping member and the second engaged portion of the electronic device.

(7) In the clamping device according to any one of (1) to (6), the distance between the first engaging portion and the second engaging portion in a first direction passing through the first engaging portion and the second engaging portion may be greater than the distance between the first adjusting portion and the second adjusting portion in a second direction passing through the first adjusting portion and the second adjusting portion, the first direction extending along the first tangent line to the outer circumferential surface of the handlebar, and the second direction extending along the second tangent line to the outer circumferential surface of the handlebar. Accordingly, the distance between the first engaging portion and the second engaging portion increases, thereby improving stability of the clamping device in supporting the electronic device. Since the distance between the first adjusting portion and the second adjusting portion decreases, the fastening unit can be prevented from standing out by the handlebar.

(8) In the clamping device according to any one of (1) to (7), when an angular position of an intermediate position between the first engaging portion and the second engaging portion is set to 0 degrees in the circumferential direction of the handlebar, at least one of the first adjusting portion and the second adjusting portion may be located in a range of 90 degrees to 270 degrees. Accordingly, it is possible to prevent a decrease in strength of the first clamping member due to an excessive decrease in a distance between the first adjusting portion and the first engaging portion. It is possible to prevent a decrease in strength of the second clamping member due to an excessive decrease in a distance between the second adjusting portion and the second engaging portion.

(9) In the clamping device according to any one of (1) to (8), when an angular position of an intermediate position between the first engaging portion and the second engaging portion is set to 0 degrees in the circumferential direction of the handlebar, an intermediate position between the first adjusting portion and the second adjusting portion may be located in a range of 135 degrees to 225 degrees. Accordingly, the first clamping member and the second clamping member can have sizes similar to each other. As a result, a difference in stress acting on each of the two clamping members can be reduced.

(10) In the clamping device according to any one of (1) to (9), the first plane passing through the first engaging portion and the second engaging portion may be substantially parallel to a direction in which the first adjusting portion and the second adjusting portion face each other, the first plane extending along the first tangent line to the outer circumferential surface of the handlebar. Accordingly, the fastening unit can be operated from a front side or a rear side of the clamping device when the clamping device is attached to the handlebar. As a result, position adjustment of the two adjusting portions by the fastening unit can be facilitated.

(11) In the clamping device according to any one of (1) to (9), the first plane passing through the first engaging portion and the second engaging portion may intersect with a direction in which the first adjusting portion and the second adjusting portion face each other, the first plane extending along the first tangent line to the outer circumferential surface of the handlebar.

(12) An example of an electronic device assembly proposed in the present disclosure includes the clamping device according to any one of (1) to (11) and the electronic device.

(13) An example of a bicycle proposed in the present disclosure includes the clamping device according to any one of (1) to (11), the electronic device, and the handlebar.

### BRIEF DESCRIPTION OF THE DRAWINGS

FIG. 1 is a side view of a bicycle proposed in the present disclosure;

FIG. 2 is a perspective view of an electronic device assembly including a clamping device and an electronic device proposed in the present disclosure;

FIG. 3 is a perspective view of the electronic device assembly;

FIG. 4 is a perspective view of the clamping device;

FIG. 5 is an exploded perspective view of the clamping device;

FIG. 6A is a side view of the clamping device;

FIG. 6B is an enlarged view of an engaging portion of the clamping device;

FIG. 7 is a perspective view illustrating another example of the clamping device; and

FIG. 8 is a side view of the clamping device illustrated in FIG. 7.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises”, “comprising”, “includes”, and/or “including”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

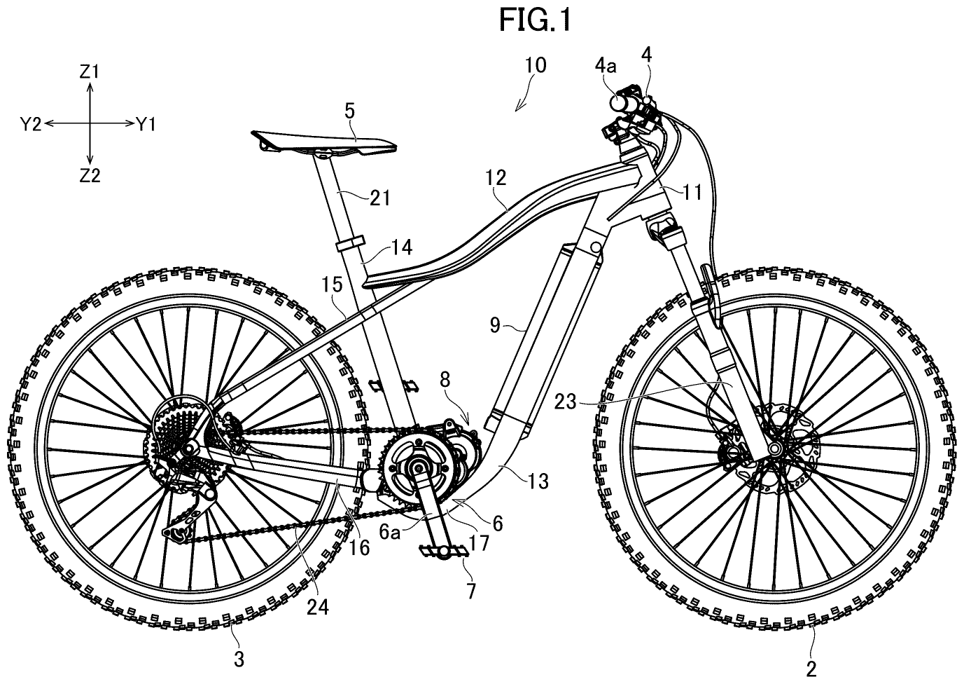

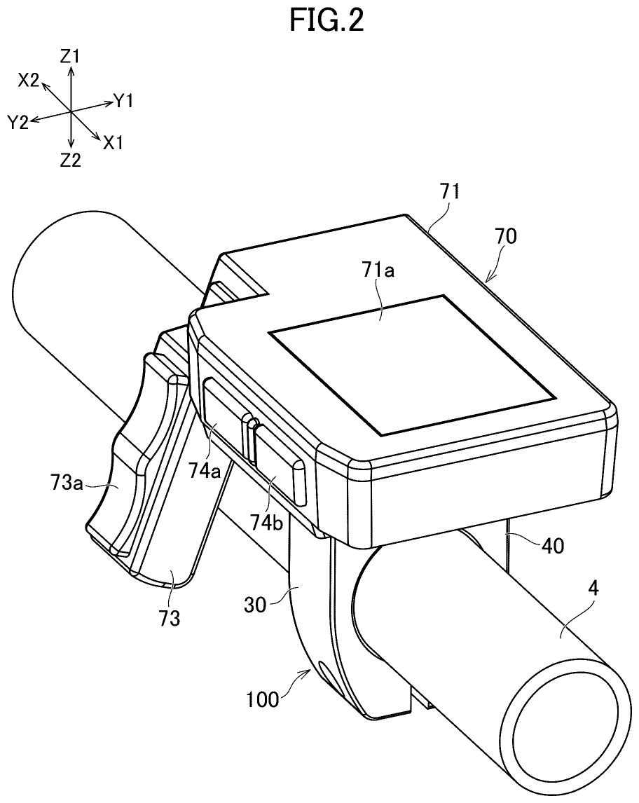

A clamping device and a bicycle proposed in the present disclosure are described below. FIG. 1 is a side view illustrating an example of the bicycle proposed in the present disclosure. FIGS. 2 to 6B are diagrams illustrating an example of the clamping device proposed in the present disclosure.

In the following description, a Y1 direction and a Y2 direction illustrated in FIG. 2 or the like will be respectively referred to as a front side and a rear side. An X1 direction and an X2 direction illustrated in the drawing are respectively referred to as a right side and a left side, and a Z1 direction and a Z2 direction are respectively referred to as an upper side and a lower side. A Y1-Y2 direction is referred to as a front-rear direction, and a Z1-Z2 direction is referred to as an up-down direction. An X1-X2 direction is referred to as a left-right direction, or a longitudinal direction of a handlebar described below. Since the clamping device may be attached obliquely to a handlebar of the bicycle, the front-rear direction (Y1-Y2 direction), the left-right direction (X1-X2 direction), and the up-down direction (Z1-Z2 direction) illustrated in FIG. 2 or the like do not have to completely match the front-rear direction, the left-right direction, and the up-down direction of the bicycle.

### [Bicycle]

As illustrated in FIG. 1, a bicycle 10 includes a body frame 1, a front wheel 2, a rear wheel 3, a handlebar 4, a saddle 5, a crank 6, and a pedal 7. The bicycle 10 is an electrically assisted bicycle and may include a drive unit 8 and a battery 9 that supplies power to the drive unit 8.

As illustrated in FIG. 1, the body frame 1 has a head pipe 11 at a front end thereof. The head pipe 11 rotatably supports a steering shaft. The handlebar 4 is fixed to an upper portion of the steering shaft. A grip 4a is provided at each of a right end and a left end of the handlebar 4. A front fork 23 that rotatably supports the front wheel 2 is fixed to a lower portion of the steering shaft.

As illustrated in FIG. 1, the body frame 1 may have, for example, a top frame 12, a down frame 13, a seat tube 14, a seat stay 15, a chain stay 16, and a bracket 17. The top frame 12 extends obliquely rearward and downward from the head pipe 11 and is connected at a rear end thereof to the seat tube 14. The down frame 13 extends obliquely rearward and downward from the head pipe 11 and is disposed below the top frame 12. A rear end of the down frame 13 is connected to the bracket 17.

A seat post 21 extends upward from the seat tube 14 and supports the saddle 5 disposed above it. The bracket 17 is connected to a lower end of the seat tube 14. The seat stay 15 extends obliquely rearward and downward from the seat tube 14. The chain stay 16 extends rearward from the bracket 17. A lower end (rear end) of the seat stay 15 and a rear end of the chain stay 16 are connected. The rear wheel 3 is rotatably supported at the connection position between them.

The crank 6 has a crank in a width direction of a vehicle body and a crank arm 6a that rotates around the crank shaft. The pedal 7 is attached to a tip of the crank arm 6a. A chain 24 is stretched between a sprocket provided on the crank shaft and a sprocket provided on an axle of the rear wheel 3.

The drive unit 8 includes an electric motor and a deceleration mechanism, and is held by the bracket 17. The drive unit 8 can transmit torque to the crank 6 and the sprocket. Therefore, a force acting on the pedal 7 (force from a rider stepping on the pedal 7) and torque output by the drive unit 8 are transmitted to the rear wheel 3 via the chain 24.

The bicycle proposed in the present disclosure does not necessarily include the drive unit 8 described herein. A structure of the body frame 1 is not necessarily limited to the example illustrated in FIG. 1. For example, the body frame 1 does not necessarily have the top frame 12.

As illustrated in FIG. 2, a clamping device 100 is attached to the handlebar 4. An electronic device 70 is supported by the handlebar 4 via the clamping device 100. As will be described below, the electronic device 70 is detachable from the clamping device 100. The clamping device 100 and the electronic device 70 form an electronic device assembly.

### [Electronic Device]

The electronic device 70 may be connected to a control device (not illustrated) or a sensor mounted on the bicycle 10 via a cable. The electronic device 70 includes a display device 71a, and displays information received from the control device or the sensor, specifically information indicating status of the bicycle 10, on the display device 71a. The information displayed on the display device 71a may be, for example, vehicle speed, traveled distance, number of pedal revolutions, and the like. The electronic device 70 may display information related to the drive unit 8, such as an amount of remaining charge of the battery 9 or an operating mode of the drive unit 8, as information indicating the status of the bicycle 10. The operating mode includes, for example, a strong mode in which the torque output by the drive unit 8 is relatively large, a weak mode in which the torque is relatively small, and a medium mode in which the torque is intermediate between the strong mode and the weak mode.

The control device mounted on the bicycle 10 may control the drive unit 8 based on an output signal from various sensors. Here, the information indicating the status of the bicycle 10 described above may be transmitted from the control device to the electronic device 70. Alternatively, the output signal from the various sensors (for example, a speed sensor or a pedaling force sensor) mounted on the bicycle 10 may be transmitted directly to the electronic device 70. Here, based on the output signal of the sensor, the electronic device 70 may output a signal for controlling the electric motor of the drive unit 8 (for example, a current command value) to a drive circuit that supplies power to the electric motor.

As illustrated in FIG. 2, the electronic device 70 may have a plurality of buttons 74a and 74b. The buttons 74a and 74b may be provided on a front surface of a main body 71 of the electronic device 70.

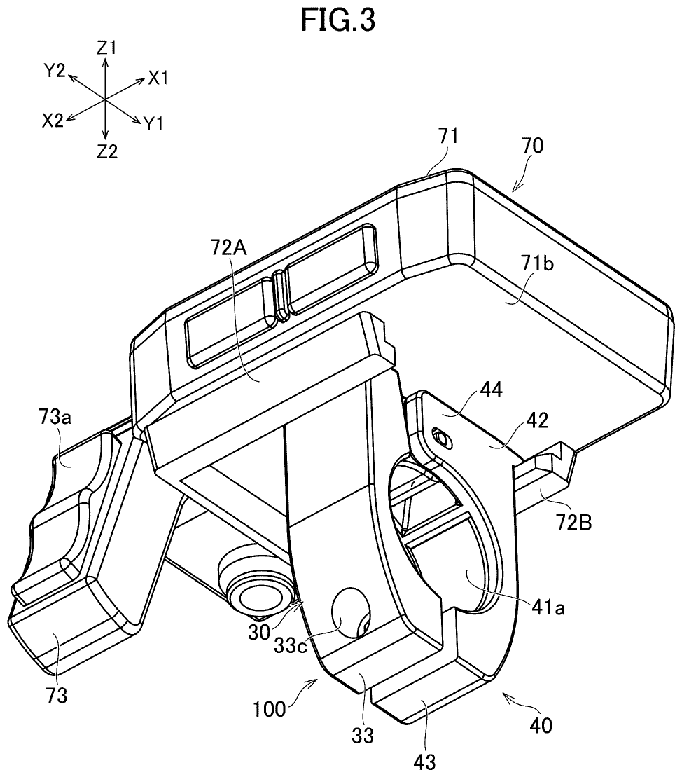

As illustrated in FIG. 3, the electronic device 70 includes a first engaged portion 72A and a second engaged portion 72B on a lower surface 71b thereof. The engaged portions 72A and 72B protrude downward from the lower surface 71b of the electronic device 70. The two engaged portions 72A and 72B are separated in the front-rear direction and face each other.

### [Clamping Device]

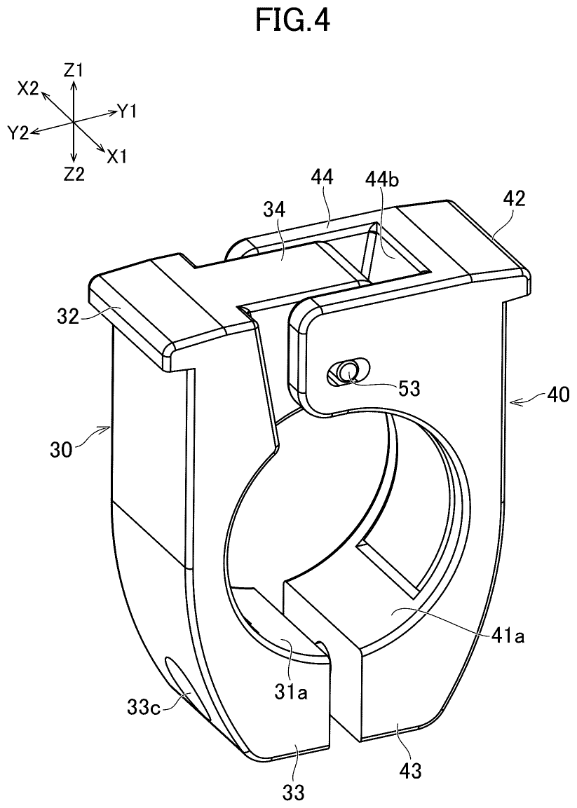

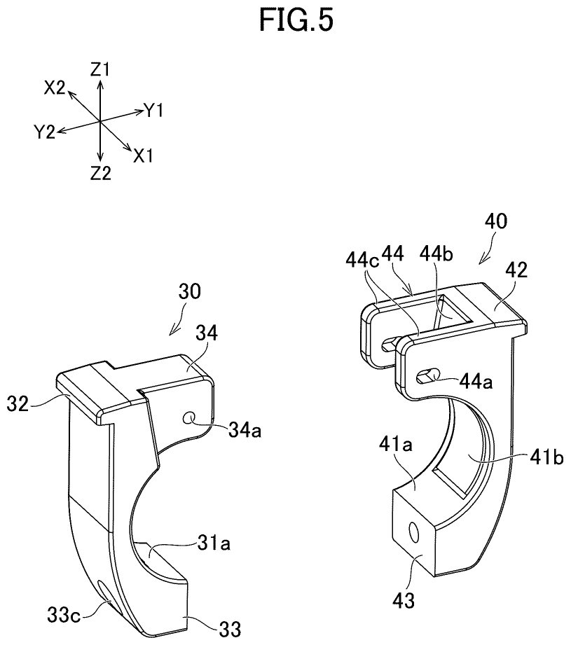

As illustrated in FIGS. 4 and 5, the clamping device 100 includes a first clamping member 30 and a second clamping member 40 that are assembled together.

The first clamping member 30 has a first inner circumferential surface 31a fitted along a portion of an outer circumferential surface of the handlebar 4. The second clamping member 40 has a second inner circumferential surface 41a fitted along another portion of the outer circumferential surface of the handlebar 4. The handlebar 4 may have a circular cross section. The inner circumferential surfaces 31a and 41a may be arc-shaped to be fitted along the outer circumferential surface of the handlebar 4.

The inner circumferential surfaces 31a and 41a are disposed to face each other and interpose the outer circumferential surface of the handlebar 4 in the front-rear direction. A diameter of the inner circumferential surfaces 31a and 41a and a diameter of the outer circumferential surface of the handlebar 4 are not necessarily completely equal to each other. For example, a gap may be partially formed between the inner circumferential surfaces 31a and 41a and the outer circumferential surface of the handlebar 4.

As illustrated in FIG. 5, the inner circumferential surface 41a of the second clamping member 40 may have an anti-slip sheet 41b. Similarly, the inner circumferential surface 31a of the first clamping member 30 may have an anti-slip sheet.

### [Engaging Portion of Clamping Member]

As illustrated in FIG. 4, the first clamping member 30 includes a first engaging portion 32 engageable with the first engaged portion 72A of the electronic device 70 at the top of the first clamping member 30. Similarly, the second clamping member 40 includes a second engaging portion 42 engageable with the second engaged portion 72B of the electronic device 70 at the top of the second clamping member 40.

As illustrated in FIG. 3, the two engaged portions 72A and 72B of the electronic device 70 are formed to face each other in a tangential direction of the outer circumferential surface of the handlebar 4 (a direction of a tangent line passing through an upper end of the outer circumferential surface, the Y1-Y2 direction in FIG. 3). The inner circumferential surfaces 31a and 41a of the clamping members 30 and 40 are curved to be fitted along the outer circumferential surface of the handlebar 4. Therefore, “tangential direction of the outer circumferential surface of the handlebar 4” is also a tangential direction of a cylindrical surface formed by the inner circumferential surfaces 31a and 41a.

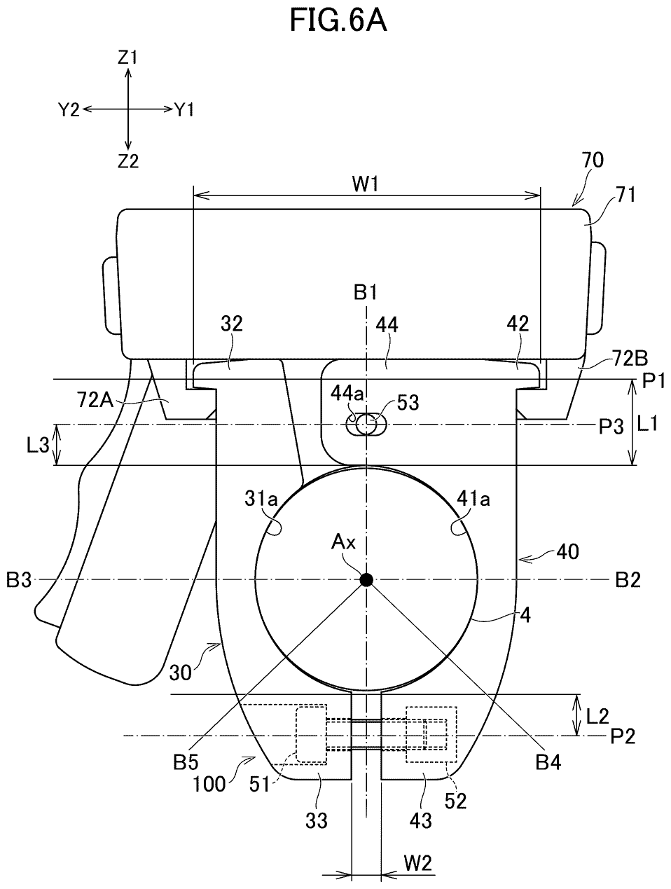

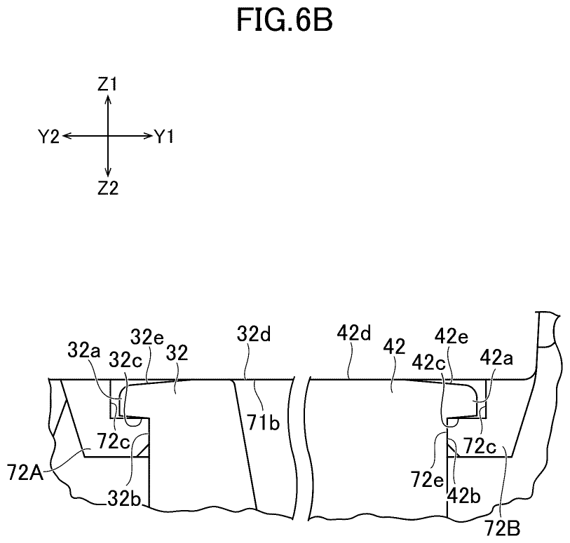

As illustrated in FIG. 6A, the engaging portions 32 and 42 of the clamping members 30 and 40 are disposed between the engaged portions 72A and 72B of the electronic device 70 in the tangential direction of the outer circumferential surface of the handlebar 4, and respectively engage with the engaged portions 72A and 72B. Accordingly, relative movement between the engaging portions 32 and 42 and the engaged portions 72A and 72B in the tangential direction of the outer circumferential surface of the handlebar 4 is restricted. Meanwhile, relative movement between the engaged portions 72A and 72B and the engaging portions 32 and 42 in the longitudinal direction of the handlebar 4 (the X1-X2 direction) is permitted.

As illustrated in FIG. 6B, the engaged portions 72A and 72B of the electronic device 70 may be substantially L-shaped. The engaging portions 32 and 42 of the clamping device 100 may also be substantially L-shaped. Protrusion portions 32a and 42a of the engaging portions 32 and 42 may be fitted into recess portions 72c formed in the engaged portions 72A and 72B. Accordingly, relative movement between the engaged portions 72A and 72B and the engaging portions 32 and 42 in the longitudinal direction of the handlebar 4 is allowed. On the other hand, relative movement between the same portions in the circumferential and tangential directions of the outer circumferential surface of the handlebar 4 is restricted.

### [Adjusting Portion of Clamping Member]

As illustrated in FIG. 6A, the first clamping member 30 includes a first adjusting portion 33 at a bottom portion thereof. The second clamping member 40 includes a second adjusting portion 43 at a bottom portion thereof. The two adjusting portions 33 and 43 face each other in the tangential direction of the outer circumferential surface of the handlebar 4 (a direction of the tangent line passing through the lower end of the outer circumferential surface, the Y1-Y2 direction in FIG. 6A).

The clamping device 100 includes a fastening unit which fixes a distance W2 between the adjusting portions 33 and 43 (see FIG. 6A). The clamping device 100 may include, for example, a bolt 51 and a nut 52 as fastening unit. The nut 52 is held by the second adjusting portion 43. A hole 33c into which the bolt 51 is inserted is formed on the first adjusting portion 33 (see FIG. 4). The bolt 51 is inserted into the hole 33c from a rear side of the first adjusting portion 33 (a side opposite to the second adjusting portion 43) and is fastened to the nut 52. As a result, the distance W2 between the adjusting portions 33 and 43 is fixed.

When the second clamping member 40 is molded from resin, the nut 52 may be held inside the second adjusting portion 43 by insert molding. Alternatively, an accommodating recess portion may be formed in the second adjusting portion 43, and the nut 52 may be inserted into the accommodating recess portion.

### [Movement of Clamping Member Due to Operation of Fastening Unit]

When the bolt 51 is tightened, the distance W2 between the adjusting portions 33 and 43 (see FIG. 6A) decreases. Conversely, when the bolt 51 is loosened, the distance W2 between the adjusting portions 33 and 43 is allowed to increase. A distance W1 between the first engaging portion 32 and the second engaging portion 42 (see FIG. 6A) in the tangential direction of the outer circumferential surface of the handlebar 4 (a direction of the tangent line passing through the upper end of the outer circumferential surface) is allowed to be decreased or increased.

As illustrated in FIG. 6A, when the inner circumferential surfaces 31a and 41a interpose the handlebar 4 therebetween, the distance W1 between the first engaging portion 32 and the second engaging portion 42 increases due to a decrease in the distance W2 between the adjusting portions 33 and 43. As a result, the first engaging portion 32 and the second engaging portion 42 are respectively pressed against the first engaged portion 72A and the second engaged portion 72B of the electronic device 70. A contact force (friction force) between the engaging portions 32 and 42 and the engaged portions 72A and 72B becomes large, and the relative position of the clamping device 100 and the electronic device 70 in the longitudinal direction of the handlebar 4 is fixed. When the distance W2 of the adjusting portions 33 and 43 decreases, a contact force between the inner circumferential surfaces 31a and 41a and the outer circumferential surface of the handlebar 4 increases. Therefore, the position of the clamping device 100 on the handlebar 4 is also fixed.

Conversely, an increase in the distance W2 between the adjusting portions 33 and 43 allows the distance W1 between the first engaging portion 32 and the second engaging portion 42 to be decreased. Accordingly, the contact force between the first engaging portion 32 and the first engaged portion 72A and the contact force between the second engaging portion 42 and the second engaged portion 72B are weakened, thereby allowing the relative position of the clamping device 100 and the electronic device 70 to change in the longitudinal direction of the handlebar 4. In addition, the contact force between the inner circumferential surfaces 31a and 41a and the outer circumferential surface of the handlebar 4 is reduced. Accordingly, position adjustment of the clamping device 100 on the handlebar 4 is possible.

By using the clamping device 100 as such, it is possible to adjust both of the relative position of the clamping device 100 and the electronic device 70, and the position of the clamping device 100 on the handlebar 4 simply by operating a single fastening unit (the bolt 51).

The first clamping member 30 and the second clamping member 40 are connected to each other only via a connecting shaft portion 53 described below, and are not connected to each other in any other portions. Therefore, when the distance W2 of the adjusting portions 33 and 43 is decreased or increased, the distance W1 of the engaging portions 32 and 42 is increased or decreased accordingly.

### [Size of Clamping Device]

As illustrated in FIG. 3, the engaged portions 72A and 72B of the electronic device 70 extend in the longitudinal direction of the handlebar 4 (the X1-X2 direction). A size of the engaged portions 72A and 72B in the longitudinal direction of the handlebar 4 (X1-X2 direction) is different from a size of the clamping members 30 and 40 in the same direction. More specifically, the size of the engaged portions 72A and 72B of the electronic device 70 is larger than the size of the clamping members 30 and 40 in the same direction. The engaging portions 32 and 42 are relatively slidable along the engaged portions 72A and 72B. The relative position of the electronic device 70 and the clamping device 100 can be adjusted within a range of the engaged portions 72A and 72B.

As illustrated in FIG. 3, the electronic device 70 includes an operation unit 73 on the left side. The operation unit 73 extends downward from the main body 71. The operation unit 73 is provided with a switch 73a. The switch 73a may be, for example, a switch for switching the operating mode of the drive unit 8 (strong mode, medium mode, weak mode). The switch 73a may also be an on/off switch for a lighting device.

The engaged portions 72A and 72B are formed on the lower surface 71b of the main body 71 closer to the left side. That is, the engaged portions 72A and 72B are formed closer to the operation unit 73. Centers of the engaged portions 72A and 72B in the left-right direction (the longitudinal direction of the handlebar 4) are located to the left of a center of the main body 71 of the electronic device 70 in the left-right direction. Such engaged portions 72A and 72B can prevent the clamping device 100 from supporting the right portion of the main body 71 (a position far from the operation unit 73). As a result, for example, when the operation unit 73 is pressed, support of the electronic device 70 can be prevented from becoming unstable.

When the bolt 51 is tightened, a force is applied to the first adjusting portion 33 from the fastening unit (the bolt 51), and the first adjusting portion 33 is moved forward (in the Y1 direction). Here, the inner circumferential surface 31a is pressed against the outer circumferential surface of the handlebar 4. The first engaging portion 32 is moved in an opposite direction to the first adjusting portion 33, that is, rearward (in the Y2 direction), and is pressed against the first engaged portion 72A of the electronic device 70. In other words, in these movements, the first adjusting portion 33, the contact surface between the inner circumferential surface 31a and the outer circumferential surface of the handlebar 4, and the first engaging portion 32 respectively function as a point of effort, a fulcrum point, and a point of load.

When the bolt 51 is tightened, a force is applied to the second adjusting portion 43 from the fastening unit (the nut 52), and the second adjusting portion 43 is moved rearward (in the Y2 direction). Here, the inner circumferential surface 41a is pressed against the outer circumferential surface of the handlebar 4. The second engaging portion 42 is moved in an opposite direction to the second adjusting portion 43, that is, forward (in the Y1 direction), and is pressed against the second engaged portion 72B of the electronic device 70. In other words, in these movements, the second adjusting portion 43, the contact surface between the inner circumferential surface 41a and the outer circumferential surface of the handlebar 4, and the second engaging portion 42 respectively function as a point of effort, a fulcrum point, and a point of load.

### [Details of Engagement Structure]

As illustrated in FIG. 6B, a rear surface 32b (the surface facing the Y2 direction) of a base of the first engaging portion 32 is pressed against a tip of a protrusion portion 72e of the first engaged portion 72A. A base of a lower surface 32c of the protrusion portion 32a of the first engaging portion 32 is also pressed against the tip of the protrusion portion 72e of the first engaged portion 72A. An upper surface 32d of the first engaging portion 32 (an upper surface of the first clamping member 30) is pressed against the lower surface 71b of the electronic device 70.

Similarly, a front surface 42b (a surface facing the Y1 direction) of a base of the second engaging portion 42 is pressed against a tip of the protrusion portion 72e of the second engaged portion 72B. A base of a lower surface 42c of the protrusion portion 42a of the second engaging portion 42 is also pressed against the tip of the protrusion portion 72e of the second engaged portion 72B. An upper surface 42d of the second engaging portion 42 (an upper surface of the second clamping member 40) is pressed against the lower surface 71b of the electronic device 70.

With such a structure, when the distance W2 between the adjusting portions 33 and 43 (see FIG. 6A) decreases, the clamping members 30 and 40 are rotated along the outer circumferential surface of the handlebar 4 so that the distance W1 between the two engaging portions 32 and 42 increases. As a result, the contact force at each of the above-described portions increases. In particular, between the engaging portions 32 and 42 and the engaged portions 72A and 72B, not only the contact force in the front-rear direction but also the contact force in the up-down direction increases. The contact force in the up-down direction is specifically the contact force between the upper surfaces 32d and 42d of the engaging portions 32 and 42 and the lower surface 71b of the electronic device 70, and the contact force between the lower surfaces 32c and 42c of the engaging portions 32 and 42 and the engaged portions 72A and 72B. Accordingly, the relative position of the electronic device 70 regarding the clamping device 100 is fixed in the front-rear direction, the up-down direction, and the left-right direction.

As illustrated in FIG. 6B, the upper surfaces 32d and 42d of the engaging portions 32 and 42 respectively have inclined surfaces 32e and 42e. The inclined surfaces 32e and 42e are gradually lowered toward the tips of the protruding portions 32a and 42a.

When the distance W2 between the adjusting portions 33 and 43 increases, the clamping members 30 and 40 are rotated along the outer circumferential surface of the handlebar 4 so that the distance W1 between the two engaging portions 32 and 42 decreases. Therefore, the engaging portions 32 and 42 are separated from the protruding portions 72e of the engaged portions 72A and 72B. Here, the inclined surfaces 32e and 42e face straight up (that is, the inclined surfaces 32e and 42e come in contact with the lower surface 71b of the main body 71). Accordingly, the contact force between the engaging portions 32 and 42 and the lower surface 71b of the main body 71 decreases, making it possible to move the electronic device 70 in the left-right direction regarding the clamping device 100. The clamping device 100 itself can also be moved in the left-right direction.

Each of the clamping members 30 and 40 may be integrally molded from resin. Here, when the bolt 51 is tightened, the clamping members 30 and 40 can be slightly elastically deformed. As a result, the engagement between the engaging portions 32 and 42 and the engaged portions 72A and 72B can be prevented from loosening due to vibration of the bicycle 10, for example. Alternatively, the clamping members 30 and 40 may be made of metal.

### [Connected Portion of Clamping Member and Connecting Shaft Portion]

As illustrated in FIG. 5, the first clamping member 30 and the second clamping member 40 respectively have a first connected portion 34 and a second connected portion 44. The connected portions 34 and 44 are located between the two engaging portions 32 and 42.

In detail, in a plan view of the clamping device 100, the connected portions 34 and 44 are located between the engaging portions 32 and 42. In a side view of the clamping device 100, the engaging portions 32 and 42 and the connected portions 34 and 44 are located in the same direction regarding the outer circumferential surface of the handlebar 4. In detail, a plane P1 (see FIG. 6A) passing through the engaging portions 32 and 42 and extending along a tangent line to the outer circumferential surface of the handlebar 4 is located above the outer circumferential surface of the handlebar 4. Similar to the engaging portions 32 and 42, the connected portions 34 and 44 are located above the outer circumferential surface of the handlebar 4.

As illustrated in FIGS. 4 and 5, the two connected portions 34 and 44 are assembled together. In detail, a recess portion 44b (see FIG. 5) may be formed in the second connected portion 44. The first connected portion 34 may be fitted into the recess portion 44b. The second connected portion 44 may have two side wall portions 44c. The recess portion 44b may be formed between the two side wall portions 44c. The first connected portion 34 overlaps with the side wall portion 44c of the second connected portion 44 in a side view of the clamping device 100.

The clamping device 100 includes the connecting shaft portion 53 (see FIG. 4) that connects the connected portions 34 and 44 together. The connecting shaft portion 53 is inserted into the connected portions 34 and 44 in the longitudinal direction of the handlebar 4. The connecting shaft portion 53 can prevent the two clamping members 30 and 40 from being separated. Therefore, for example, the work of attaching the clamping device 100 to the handlebar 4 can be facilitated.

The first clamping member 30 and the second clamping member 40 can move around the connecting shaft portion 53 so that the distance W2 between the first adjusting portion 33 and the second adjusting portion 43 can be increased or decreased. The clamping members 30 and 40 may be openable so that the distance W2 of the adjusting portions 33 and 43 is greater than a diameter of the outer circumferential surface of the handlebar 4. Accordingly, it is possible to further facilitate the work of attaching the clamping device 100 to the handlebar 4.

A hole 34a is formed through the first connected portion 34. The connecting shaft portion 53 is inserted into the hole 34a. Both ends of the connecting shaft portion 53 protrude from the first connected portion 34 in the longitudinal direction of the handlebar 4. A connecting hole 44a is formed through the side wall portion 44c of the second connected portion 44. The connecting shaft portion 53 is inserted into the connecting hole 44a.

A relative position of the first connected portion 34 and the connecting shaft portion 53 is fixed. In other words, the connecting shaft portion 53 is held by the first connected portion 34. The connecting shaft portion 53 may be press-fitted into the hole 34a of the first connected portion 34. A size of the connecting hole 44a of the second connected portion 44 is larger than a size of the connecting shaft portion 53. More specifically, a width of the connecting hole 44a in a direction extending along a tangent line to the outer circumferential surface of the handlebar 4 (a tangent line passing through the upper end of the outer circumferential surface) and passing through the engaging portions 32 and 42 (a direction extending along the plane P1 in FIG. 6A) is larger than that of the connecting shaft portion 53.

As a result, the connecting shaft portion 53 connects the connected portions 34 and 44 and allows the distance W1 between the first engaging portion 32 and the second engaging portion 42 to change. In an example illustrated in FIG. 5 and the like, the connecting hole 44a is an elongated hole extending in a direction passing through the engaging portions 32 and 42. However, the connecting hole 44a may be circular or elliptical.

The connecting shaft portion 53 is a member formed separately from the first clamping member 30, and may be inserted into the holes 34a and 44a of the two connected portions 34 and 44 after the two connected portions 34 and 44 are assembled together.

### [Position of Connecting Shaft Portion]

In FIG. 6A, the plane P1 is a plane extending along a tangent line to the outer circumferential surface of the handlebar 4 (a plane passing through the upper end of the outer circumferential surface) and passing through the two engaging portions 32 and 42. More specifically, the plane P1 is a plane passing through the protrusion portions 32a and 42a of the engaging portions 32 and 42. In FIG. 6A, a plane P3 is a plane parallel to the plane P1 and passing through the connecting shaft portion 53.

As illustrated in FIG. 6A, a distance L3 from the outer circumferential surface of the handlebar 4 to the plane P3 is smaller than a distance L1 from the outer circumferential surface of the handlebar 4 to the plane P1. According such an arrangement of the connecting shaft portion 53, the distance between the outer circumferential surface of the handlebar 4 and the connecting shaft portion 53 is small, so that a change in the relative position of the connecting shaft portion 53 and the connecting hole 44a of the second connected portion 44 can be decreased. As a result, the connecting hole 44a having a short length is sufficient, making it easy to ensure the strength of the second connected portion 44.

### [Positional Relationship Between Engaging Portion and Adjusting Portion]

In FIG. 6A, a plane P2 is a plane extending along a tangent line to the outer circumferential surface of the handlebar 4 (a tangent line passing through the lower end of the outer circumferential surface) and passing through the two adjusting portions 33 and 43. More specifically, the plane P2 is a plane passing through centers of the adjusting portions 33 and 43 (centers of the bolt 51 and the nut 52).

The distance L1 from the outer circumferential surface of the handlebar 4 to the plane P1 is greater than a distance L2 from the outer circumferential surface of the handlebar 4 to the plane P2. According to such a structure, the position of the electronic device 70 is far from the handlebar 4, so that it is easy to avoid interference between the electronic device 70 and other parts attached to the handlebar 4. When the bolt 51 is strongly tightened, it is possible to prevent an excessive force from acting between the engaging portions 32 and 42 of the clamping members 30 and 40 and the engaged portions 72A and 72B of the electronic device 70. As a result, for example, plastic deformation of the clamping members 30 and 40 can be prevented. Note that the distance L1 from the outer circumferential surface of the handlebar 4 to the plane P1 may be smaller than the distance L2 from the outer circumferential surface of the handlebar 4 to the plane P2, unlike the example illustrated in FIG. 6A.

As illustrated in FIG. 6A, the distance W1 between the first engaging portion 32 and the second engaging portion 42 is greater than the distance W2 between the first adjusting portion 33 and the second adjusting portion 43. It is preferable that the distance W1 between the first engaging portion 32 and the second engaging portion 42 be greater than the diameter of the outer circumferential surface of the handlebar 4. Accordingly, the distance W1 becomes large, and support stability of the electronic device 70 by the clamping device 100 can be improved. Meanwhile, it is preferable that the distance W2 between the first adjusting portion 33 and the second adjusting portion 43 be smaller than the diameter of the outer circumferential surface of the handlebar 4. Accordingly, the fastening unit (the bolt 51 and the nut 52) can be prevented from standing out due to the handlebar 4.

As illustrated in FIG. 6A, a line B1 is a line passing through an axis Ax of the handlebar 4 and an intermediate position between the first engaging portion 32 and the second engaging portion 42. When an angular position of the line B1 in the circumferential direction of the handlebar 4 is set to 0 degrees, it is preferable that at least one of the two adjusting portions 33 and 43 is located in a range of 90 degrees to 270 degrees. In other words, it is preferable that at least one of the two adjusting portions 33 and 43 is located between a line B2 (a line indicating a position of 90 degrees) and a line B3 (a line indicating a position of 270 degrees) in the circumferential direction of the handlebar 4.

As illustrated in FIG. 6A, it is preferable that at least one of the two adjusting portions 33 and 43 is located in a range of 135 degrees to 225 degrees. In other words, it is preferable that at least one of the two adjusting portions 33 and 43 is located between a line B4 (a line indicating a position of 135 degrees) and a line B5 (a line indicating a position of 225 degrees) in the circumferential direction of the handlebar 4. According to such a structure, the two clamping members 30 and 40 can have sizes similar to each other. As a result, a difference in stress acting on the two clamping members 30 and 40 can be decreased.

In the example illustrated in FIG. 6A, the two adjusting portions 33 and 43 and the fastening unit (the bolt 51 and the nut 52) are located in the range from 135 degrees (the line B4) to 225 degrees (the line B5). An intermediate position of the adjusting portions 33 and 43 is located on the opposite side to the intermediate position of the engaging portions 32, 42 with the axis Ax of the handlebar 4 interposed therebetween. As a result, the engaging portions 32 and 42, to which a large force is applied, are located separately from the hole 33c for inserting the bolt 51 formed in the first adjusting portion 33 and an internal gap of the second adjusting portion 43 in which the nut 52 is disposed. Therefore, it is possible to prevent a decrease in the strength of the engaging portions 32 and 42 (rigidity of the resin around the engaging portions 32 and 42) caused by the hole 33c and the gap for the nut 52 being located close thereto.

As illustrated in FIG. 6A, the above-described plane P1 passing through the first engaging portion 32 and the second engaging portion 42 and a direction in which the first adjusting portion 33 and the second adjusting portion 43 face each other (insertion direction of the bolt 51) may be substantially parallel. According to such a structure, during a tightening operation of the fastening unit (specifically, the bolt 51), the bolt 51 can be easily seen so that the tightening operation is facilitated. For example, a head of the bolt 51 is exposed to the rear, which facilitates the tightening operation of the bolt 51. Here, “substantially parallel” also includes cases where the plane P1 and the direction in which the adjusting portions 33 and 43 face each other are not completely parallel, but are tilted, for example, in a range of 0 degrees to 10 degrees.

### [Another Example of Clamping Device]

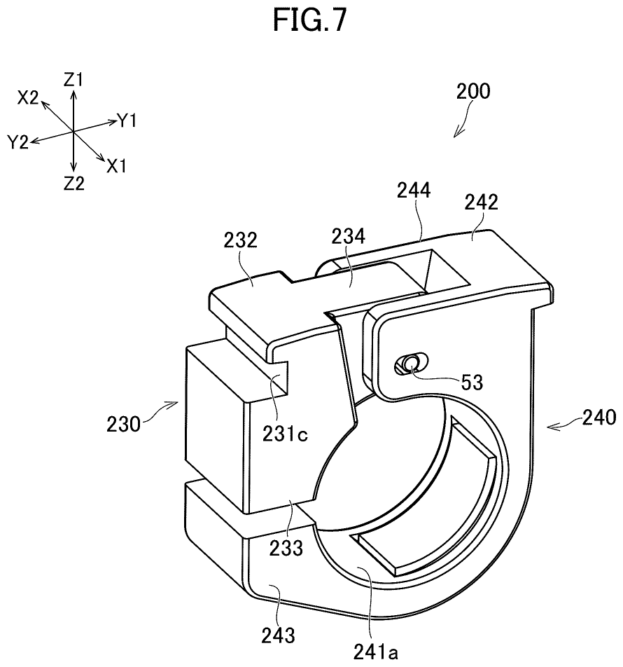

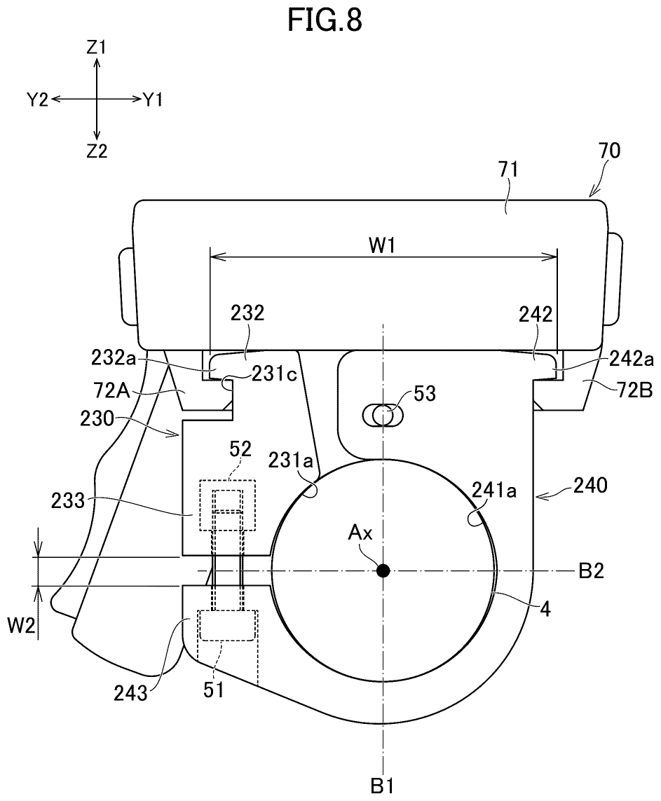

FIGS. 7 and 8 are diagrams illustrating a modification example of the clamping device proposed in the present disclosure. The following description will focus on differences between a clamping device 200 illustrated in FIGS. 7 and 8 and the clamping device 100 illustrated in FIGS. 2 to 6B. Matters that are not described regarding the clamping device 200 may be similar to those of the clamping device 100.

As illustrated in FIG. 7, the clamping device 200 includes a first clamping member 230 and a second clamping member 240. The first clamping member 230 has a first engaging portion 232, an inner circumferential surface 231a formed along the outer circumferential surface of the handlebar 4, a first adjusting portion 233, and a first connected portion 234. The second clamping member 240 has a second engaging portion 242, an inner circumferential surface 241a formed along the outer circumferential surface of the handlebar 4, a second adjusting portion 243, and a second connected portion 244.

As illustrated in FIG. 8, the inner circumferential surface 231a of the first clamping member 230 is formed to cover along only approximately ¼ of the outer circumferential surface of the handlebar 4. The first adjusting portion 233 is located below the first engaging portion 232. In a plan view of the clamping device 200, a protrusion portion 232a of the first engaging portion 232 overlaps with the first adjusting portion 233. Meanwhile, the inner circumferential surface 241a of the second clamping member 240 surrounds approximately ¾ of the outer circumferential surface of the handlebar 4. The second adjusting portion 243 is located below the first adjusting portion 233.

As illustrated in FIG. 8, the first engaging portion 232 and the second engaging portion 242 are separated from each other in the front-rear direction (the Y1-Y2 direction in FIG. 8). Meanwhile, the first adjusting portion 233 and the second adjusting portion 243 face each other in the up-down direction (the Z1-Z2 direction in FIG. 8), unlike the example illustrated in FIG. 2 or the like. In other words, a plane P1 extending along a tangent line to the outer circumferential surface of the handlebar 4 and passing through the first engaging portion 232 and the second engaging portion 242 intersects with a direction in which the adjusting portions 233 and 243 face each other. More specifically, the plane P1 and the direction in which the adjusting portions 233 and 243 face each other may be substantially perpendicular. “Substantially perpendicular” includes not only a case in which the angle between the plane P1 and the direction in which the adjusting portions 233 and 243 face each other is 90 degrees, but also a case in which the angle is, for example, 85 degrees to 95 degrees.

The clamping device 200 includes a fastening unit which fixes a distance W2 between the adjusting portions 233 and 243 (see FIG. 8). The clamping device 200 may include the bolt 51 and the nut 52 as the fastening unit. The nut 52 may be held by the first adjusting portion 233. A hole into which the bolt 51 is inserted may be formed in the second adjusting portion 243. The bolt 51 is inserted into the hole from a lower side (a side opposite to the first adjusting portion 233) of the second adjusting portion 243 and fastened to the nut 52. As a result, the distance W2 between the adjusting portions 233 and 243 is fixed. According to such fastening unit, for example, during a tightening operation of the bolt 51, it is possible to prevent other parts and devices attached to the handlebar 4 from interfering with the fastening operation.

A line B1 illustrated in FIG. 8 is a line passing through the axis Ax of the handlebar 4 and an intermediate position between the first engaging portion 232 and the second engaging portion 242, similar to the line B1 illustrated in FIG. 6A. When an angular position of the line B1 in the circumferential direction of the handlebar 4 is set to 0 degrees, the second adjusting portion 243 of the two adjusting portions 233 and 243 is located in a range of 90 degrees to 270 degrees. That is, the second adjusting portion 243 is located between a line B2 (line indicating a position of 90 degrees) and a line B3 (line indicating a position of 270 degrees) in the circumferential direction of the handlebar 4. Meanwhile, the first adjusting portion 233 is located in a range exceeding 270 degrees (the line B3).

As illustrated in FIG. 7, a recess portion 231c is formed between the protrusion portion 232a of the first engaging portion 232 and the first adjusting portion 233. A protrusion portion of the first engaged portion 72A of the electronic device 70 is fitted into the recess portion 231c. The nut 52 is located below the recess portion 231c. In the first clamping member 30 illustrated in FIG. 6A, since the first adjusting portion 233 is located below the handlebar 4, such a recess portion is not necessary.

Movements of the first clamping member 230 and the second clamping member 240 are similar to the movements of the clamping members 30 and 40 of the clamping device 100 described above.

That is, when the bolt 51 is tightened, the distance W2 between the adjusting portions 233 and 243 (see FIG. 8) decreases. Conversely, when the bolt 51 is loosened, the distance W2 between the adjusting portions 233 and 243 is allowed to increase. A distance W1 between the first engaging portion 232 and the second engaging portion 242 (see FIG. 8) in the tangential direction of the outer circumferential surface of the handlebar 4 is allowed to decrease or increase.

When the inner circumferential surfaces 231a and 241a interpose the handlebar 4 therebetween, the distance W1 between the first engaging portion 232 and the second engaging portion 242 increases due to a decrease in the distance W2 between the adjusting portions 233 and 243. Accordingly, a contact force between the inner circumferential surfaces 231a and 241a and the outer circumferential surface of the handlebar 4 increases. Therefore, a position of the clamping device 200 on the handlebar 4 is fixed. A relative position of the clamping device 200 and the electronic device 70 in the longitudinal direction of the handlebar 4 is fixed.

Conversely, an increase in the distance W2 between the adjusting portions 233 and 243 allows the distance W1 between the first engaging portion 232 and the second engaging portion 242 to decrease. Accordingly, a contact force between the first engaging portion 232 and the first engaged portion 72A and a contact force between the second engaging portion 242 and the second engaged portion 72B is weakened. As a result, the relative position of the clamping device 200 and the electronic device 70 in the longitudinal direction of the handlebar 4 are allowed to be changed. The contact force between the inner circumferential surfaces 231a and 241a and the outer circumferential surface of the handlebar 4 also decreases. Therefore, it is also possible to adjust the position of the clamping device 200 in the longitudinal direction of the handlebar 4.

The first clamping member 230 and the second clamping member 240 are connected to each other only via the connecting shaft portion 53, and are not connected to each other in any other portions. Therefore, when the distance W2 between the adjusting portions 233 and 243 decreases or increases, the distance W1 between the engaging portions 232 and 242 accordingly increases or decreases.

### Summary

(1) Clamping devices 100 and 200 proposed in the present disclosure is for attaching an electronic device 70 including a first engaged portion 72A and a second engaged portion 72B to a handlebar 4. The clamping devices 100 and 200 includes a first clamping member 30 or 230, having a first inner circumferential surface 31a or 231a, extending along a portion of an outer circumferential surface of the handlebar 4, a first engaging portion 32 or 232 engageable with the first engaged portion 72A to allow movement of the first engaged portion 72A in a longitudinal direction of the handlebar 4, and a first adjusting portion 33 or 233, a second clamping member 40 or 240 having a second inner circumferential surface 41a extending along another portion of the outer circumferential surface of the handlebar 4, a second engaging portion 42 or 242 engageable with the second engaged portion 72B to allow movement of the second engaged portion 72B in the longitudinal direction of the handlebar 4, and a second adjusting portion 43 or 243, and a fastening unit configured to fix a distance between the first adjusting portion 33 or 233 and the second adjusting portion 43 or 243 in a circumferential direction of the handlebar 4. The first engaging portion 32 or 232 and the second engaging portion 42 or 242 are located between the first engaged portion 72A and the second engaged portion 72B in a tangential direction of the outer circumferential surface of the handlebar 4. The fastening unit allows adjustment of a distance W2 between the first adjusting portion 33 or 233 and the second adjusting portion 43 or 243. A distance W1 between the first engaging portion 32 or 232 and the second engaging portion 42 or 242 increases due to a decrease in the distance W2 between the first adjusting portion 33 or 233 and the second adjusting portion 43 or 243.

According to the clamping devices 100 and 200, both a (a) relative position of the clamping device and the handlebar 4, and a (b) relative position of the clamping device and the electronic device 70 can be adjusted or fixed by operating the fastening unit. Therefore, a work for position adjustment can be facilitated.

(2) The clamping devices 100 or 200 according to (1) may further include a connecting shaft portion 53. The first clamping member 30 or 230 and the second clamping member 40 or 240 respectively have a first connected portion 34 or 234 and a second connected portion 44 or 244 located between the first engaging portion 32 or 232 and the second engaging portion 42 or 242 in the tangential direction of the outer circumferential surface of the handlebar 4. The connecting shaft portion 53 connects the first connected portion 34 or 234 and the second connected portion 44 or 244 to allow an increase and decrease in the distance W1 between the first engaging portion 32 or 232 and the second engaging portion 42 or 242. Such a structure makes it possible to prevent separation of the two clamping members 30 and 40. As a result, the clamping devices 100 and 200 are easy to handle.

(3) In the clamping devices 100 or 200 according to (2), the connecting shaft portion 53 protrudes from the first connected portion 34 or 234 in the longitudinal direction of the handlebar 4. A connecting hole 44a into which the connecting shaft portion 53 is fitted may be formed in the second connected portion 44 or 244. The connecting hole 44a may be larger than the connecting shaft portion 53 in the tangential direction of the outer circumferential surface of the handlebar 4.

(4) In the clamping devices 100 and 200 according to (3), a distance L3 between the connecting shaft portion 53 and the outer circumferential surface of the handlebar 4 may be smaller than a distance L1 between the outer circumferential surface of the handlebar 4 and a plane P1 passing through the first engaging portion 32 or 232 and the second engaging portion 42 or 242, the plane P1 extending along a first tangent line to the outer circumferential surface of the handlebar 4. Such an arrangement of the connecting shaft portion 53 allows a size of the connecting hole 44a in the tangential direction of the outer circumferential surface of the handlebar 4 to be decreased. As a result, a decrease in strength of the second clamping member 40 or 240 due to the connecting hole 44a can be prevented.

(5) In the clamping devices 100 and 200 according to any one of (1) to (4), the first adjusting portion 33 or 233, a contact surface between the first inner circumferential surface 31a or 231a and the outer circumferential surface of the handlebar 4, and the first engaging portion 32 or 232 respectively function as a point of effort, a fulcrum point, and a point of load. The second adjusting portion 43 or 243, a contact surface between the second inner circumferential surface 41a and the outer circumferential surface of the handlebar 4, and the second engaging portion 42 or 242 respectively function as a point of effort, a fulcrum point, and a point of load.

(6) In the clamping devices 100 and 200 according to any one of (1) to (5), the distance L1 between the outer circumferential surface of the handlebar 4 and the plane P1 passing through the first engaging portion 32 or 232 and the second engaging portion 42 or 242 may be greater than a distance L2 between the outer circumferential surface of the handlebar 4 and a plane P2 passing through the first adjusting portion 33 or 233 and the second adjusting portion 43 or 243, the plane P1 extending along the first tangent line to the outer circumferential surface of the handlebar 4, and the plane P2 extending along a second tangent line to the outer circumferential surface of the handlebar 4. Accordingly, when positions of the two adjusting portions 33 and 43, or 233 and 243 are fixed by the fastening unit, it is possible to prevent an excessive force from acting between the first engaging portion 32 or 232 of the first clamping member 30 or 230 and the first engaged portion 72A of the electronic device 70, and prevent an excessive force from acting between the second engaging portion 42 or 242 of the second clamping member 40 or 240 and the second engaged portion 72B of the electronic device 70.

(7) In the clamping devices 100 and 200 according to any one of (1) to (6), the distance W1 between the first engaging portion 32 or 232 and the second engaging portion 42 or 242 in a first direction passing through the first engaging portion 32 or 232 and the second engaging portion 42 or 242 may be greater than the distance W2 between the first adjusting portion 33 or 233 and the second adjusting portion 43 or 243 in a second direction passing through the first adjusting portion 33 or 233 and the second adjusting portion 43 or 243, the first direction extending along the first tangent line to the outer circumferential surface of the handlebar 4, and the second direction extending along the second tangent line to the outer circumferential surface of the handlebar 4. Accordingly, the distance W1 between the first engaging portion 32 or 232 and the second engaging portion 42 or 242 increases, thereby improving stability of the clamping devices 100 and 200 in supporting the electronic device 70. Since the distance W2 between the first adjusting portion 33 or 233 and the second adjusting portion 43 or 243 decreases, the fastening unit (the bolt 51 and the nut 52) can be prevented from standing out.

(8) In the clamping devices 100 and 200 according to any one of (1) to (7), when an angular position of an intermediate position between the first engaging portion 32 or 232 and the second engaging portion 42 or 242 is set to 0 degrees in the circumferential direction of the handlebar 4, at least one of the first adjusting portion 33 or 233 and the second adjusting portion 43 or 243 may be located in a range of 90 degrees to 270 degrees. Accordingly, it is possible to prevent a decrease in strength of the first clamping member 30 or 230 due to an excessive decrease in a distance between the first adjusting portion 33 or 233 and the first engaging portion 32 or 232. It is possible to prevent a decrease in strength of the second clamping member 40 or 240 due to an excessive decrease in a distance between the second adjusting portion 43 or 243 and the second engaging portion 42 or 242.

(9) In the clamping device 100 according to any one of (1) to (8), when an angular position of an intermediate position between the first engaging portion 32 and the second engaging portion 42 is set to 0 degrees in the circumferential direction of the handlebar 4, an intermediate position between the first adjusting portion 33 and the second adjusting portion 43 may be located in a range of 135 degrees to 225 degrees. Accordingly, the first clamping member 30 and the second clamping member 40 can have sizes similar to each other. As a result, a difference in stress acting on each of the two clamping members 30 and 40 can be reduced.

(10) In the clamping device 100 according to any one of (1) to (9), the plane P1 passing through the first engaging portion 32 and the second engaging portion 42 may be substantially parallel to a direction in which the first adjusting portion 33 and the second adjusting portion 43 face each other, the plane P1 extending along the first tangent line to the outer circumferential surface of the handlebar 4. Accordingly, the fastening unit can be operated from a front side or a rear side of the clamping device 100 when the clamping device 100 is attached to the handlebar 4. As a result, position adjustment of the two adjusting portions 33 and 43 by the fastening unit can be facilitated.

(11) In the clamping device 200 according to any one of (1) to (9), the plane P1 passing through the first engaging portion 232 and the second engaging portion 242 may intersect with a direction in which the first adjusting portion 233 and the second adjusting portion 243 face each other, the plane P1 extending along the first tangent line to the outer circumferential surface of the handlebar 4.

(12) An electronic device assembly proposed in the present disclosure includes the clamping device 100, 200 according to any one of (1) to (11) and the electronic device 70.

(13) A bicycle 10 proposed in the present disclosure includes the clamping device 100, 200 according to any one of (1) to (11), the electronic device 70, and the handlebar 4.

### Others

The fastening unit is not limited to the bolt 51 and the nut 52 as long as the fastening unit enables fixing and adjustment of the distance W2 between the adjusting portions 33 and 43. The fastening unit may be a screw, a lever screw (clamp lever), a cam lever, or the like.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A clamping device for attaching an electronic device including a first engaged portion and a second engaged portion to a handlebar, the clamping device comprising:
a first clamping member having:
a first inner circumferential surface extending along a portion of an outer circumferential surface of the handlebar,
a first engaging portion engageable with the first engaged portion to allow movement of the first engaged portion in a longitudinal direction of the handlebar, and
a first adjusting portion;
a second clamping member having:
a second inner circumferential surface extending along another portion of the outer circumferential surface of the handlebar,
a second engaging portion engageable with the second engaged portion to allow movement of the second engaged portion in the longitudinal direction of the handlebar, and
a second adjusting portion; and
a fastening unit configured to fix a distance between the first adjusting portion and the second adjusting portion in a circumferential direction of the handlebar, wherein
the first engaging portion and the second engaging portion are located between the first engaged portion and the second engaged portion in a tangential direction of the outer circumferential surface of the handlebar,
the fastening unit allows adjustment of the distance between the first adjusting portion and the second adjusting portion, and
a distance between the first engaging portion and the second engaging portion increases due to a decrease in the distance between the first adjusting portion and the second adjusting portion.

2. The clamping device according to claim 1, further comprising:
a connecting shaft portion, wherein
the first clamping member and the second clamping member respectively have a first connected portion and a second connected portion located between the first engaging portion and the second engaging portion in the tangential direction of the outer circumferential surface of the handlebar, and
the connecting shaft portion connects the first connected portion and the second connected portion to allow an increase and decrease in the distance between the first engaging portion and the second engaging portion.

3. The clamping device according to claim 2, wherein
the connecting shaft portion protrudes from the first connected portion in the longitudinal direction of the handlebar,
a connecting hole into which the connecting shaft portion is fitted is formed in the second connected portion, and
the connecting hole is larger than the connecting shaft portion in the tangential direction of the outer circumferential surface of the handlebar.

4. The clamping device according to claim 3, wherein a distance between the connecting shaft portion and the outer circumferential surface of the handlebar is smaller than a distance between the outer circumferential surface of the handlebar and a plane passing through the first engaging portion and the second engaging portion, the plane extending along a tangent line to the outer circumferential surface of the handlebar.

5. The clamping device according to claim 1, wherein
the first adjusting portion, a contact surface between the first inner circumferential surface and the outer circumferential surface of the handlebar, and the first engaging portion respectively function as a point of effort, a fulcrum point, and a point of load, and
the second adjusting portion, a contact surface between the second inner circumferential surface and the outer circumferential surface of the handlebar, and the second engaging portion respectively function as a point of effort, a fulcrum point, and a point of load.

6. The clamping device according to claim 1, wherein a distance between the outer circumferential surface of the handlebar and a first plane passing through the first engaging portion and the second engaging portion is greater than a distance between the outer circumferential surface of the handlebar and a second plane passing through the first adjusting portion and the second adjusting portion,
the first plane extending along a tangent line to the outer circumferential surface of the handlebar, and
the second plane extending along a tangent line to the outer circumferential surface of the handlebar.

7. The clamping device according to claim 1, wherein a distance between the first engaging portion and the second engaging portion in a first direction passing through the first engaging portion and the second engaging portion is greater than a distance between the first adjusting portion and the second adjusting portion in a second direction passing through the first adjusting portion and the second adjusting portion,
the first direction extending along a tangent line to the outer circumferential surface of the handlebar, and
the second direction extending along a tangent line to the outer circumferential surface of the handlebar.

8. The clamping device according to claim 1, wherein when an angular position of an intermediate position between the first engaging portion and the second engaging portion is set to 0 degrees in the circumferential direction of the handlebar, at least one of the first adjusting portion and the second adjusting portion is located in a range of 90 degrees to 270 degrees.

9. The clamping device according to claim 1, wherein when an angular position of an intermediate position between the first engaging portion and the second engaging portion is set to 0 degrees in the circumferential direction of the handlebar, an intermediate position between the first adjusting portion and the second adjusting portion is located in a range of 135 degrees to 225 degrees.

10. The clamping device according to claim 1, wherein a plane passing through the first engaging portion and the second engaging portion is substantially parallel to a direction in which the first adjusting portion and the second adjusting portion face each other, the plane extending along a tangent line to the outer circumferential surface of the handlebar.

11. The clamping device according to claim 1, wherein a plane passing through the first engaging portion and the second engaging portion intersects with a direction in which the first adjusting portion and the second adjusting portion face each other, the plane extending along a tangent line to the outer circumferential surface of the handlebar.

12. An electronic device assembly comprising:
a clamping device including first clamping member having:
a first inner circumferential surface extending along a portion of an outer circumferential surface of a handlebar,
a first engaging portion engageable with a first engaged portion to allow movement of the first engaged portion in a longitudinal direction of the handlebar, and
a first adjusting portion;
a second clamping member having:
a second inner circumferential surface extending along another portion of the outer circumferential surface of the handlebar,
a second engaging portion engageable with a second engaged portion to allow movement of the second engaged portion in the longitudinal direction of the handlebar, and
a second adjusting portion; and
a fastening unit configured to fix a distance between the first adjusting portion and the second adjusting portion in a circumferential direction of the handlebar, wherein
the first engaging portion and the second engaging portion are located between the first engaged portion and the second engaged portion in a tangential direction of the outer circumferential surface of the handlebar,
the fastening unit allows adjustment of the distance between the first adjusting portion and the second adjusting portion, and
a distance between the first engaging portion and the second engaging portion increases due to a decrease in the distance between the first adjusting portion and the second adjusting portion; and
an electronic device configured to be held by the clamping device.

13. A bicycle comprising:
a clamping device including first clamping member having:
a first inner circumferential surface extending along a portion of an outer circumferential surface of a handlebar,
a first engaging portion engageable with a first engaged portion to allow movement of the first engaged portion in a longitudinal direction of the handlebar, and
a first adjusting portion;
a second clamping member having:
a second inner circumferential surface extending along another portion of the outer circumferential surface of the handlebar,
a second engaging portion engageable with a second engaged portion to allow movement of the second engaged portion in the longitudinal direction of the handlebar, and
a second adjusting portion; and
a fastening unit configured to fix a distance between the first adjusting portion and the second adjusting portion in a circumferential direction of the handlebar, wherein
the first engaging portion and the second engaging portion are located between the first engaged portion and the second engaged portion in a tangential direction of the outer circumferential surface of the handlebar,
the fastening unit allows adjustment of the distance between the first adjusting portion and the second adjusting portion, and
a distance between the first engaging portion and the second engaging portion increases due to a decrease in the distance between the first adjusting portion and the second adjusting portion;
the bicycle further comprising:
an electronic device held by the clamping device; and
the handlebar.
